(19) United States
(12) Patent Application Publication
(10) Pub. No.: US 2005/0264234 A1
(43) Pub. Date: Dec. 1, 2005

(54) Plasma display panel

(76) Inventors: Jae-Ik Kwon, Suwon-si (KR); Tae-Kyoung Kang, Suwon-si (KR)

Correspondence Address: MCGUIREWOODS, LLP, 1750 TYSONS BLVD, SUITE 1800, MCLEAN, VA, 22102, US

(21) Appl. No.: 11/138,356

(22) Filed: May 27, 2005

(30) Foreign Application Priority Data
May 31, 2004 (KR) 10-2004-0039257

(51) Int. Cl. G09G 3/28

(52) U.S. Cl. 315/169.4

(57) ABSTRACT

A plasma display panel including a rear substrate, a front substrate disposed separated from the rear substrate, partition walls disposed between the front substrate and the rear substrate to define discharge cells together with the front and rear substrates, sustain electrode pairs extending across the discharge cells, and address electrodes extending in a direction substantially perpendicular to the sustain electrode pairs. A sustain electrode comprises a bus electrode and a transparent electrode. The bus electrode extends across the discharge cells, and the transparent electrode comprises a body portion disposed apart from the bus electrode in a direction towards a center of a discharge cell and a connection portion electrically connecting the body portion to the bus electrode. A ratio of a width of the body portion to a length of the connection portion is in a range of 1.2 to 2.2.

### CROSS REFERENCE TO RELATED APPLICATION

This application claims priority to and the benefit of Korean Patent Application No. 10-2004-0039257, filed on May 31, 2004, which is hereby incorporated by reference for all purposes as if fully set forth herein.

### BACKGROUND OF THE INVENTION

1. Field of the Invention

The present invention relates to a plasma display panel (PDP), and more particularly, to a PDP having improved discharge stability.

2. Discussion of the Background

Recently, PDPs have been widely used to replace conventional cathode ray tube display apparatuses. In the PDP, a discharge gas is sealed between two substrates having a plurality of electrodes. Applying a discharge voltage between the electrodes generates ultraviolet rays from the discharge gas, thereby exciting fluorescent layers coated in discharge cells. Visible light then emits from the fluorescent layers to form an image.

FIG. 1 is a waveform view showing driving signals that may be used for an address display separation (ADS) driving scheme of a conventional alternating current (AC) PDP. The driving signals include driving signals Sₓ and S_{y}, which may be applied to X and Y electrodes of a sustain electrode pair, and a driving signal S_{A}, which may be applied to an address electrode, during a unit subfield SF. The unit subfield SF may be divided into a reset period R, an address period A, and a sustain period S. A discharge cell to be sustain discharged is selected during the address period, and a sustain discharge is generated in selected cells during the sustain period.

Applying a positive address voltage VA to an address electrode selects a corresponding discharge cell. On the other hand, if a discharge cell is not to be selected, a ground voltage V_{G} may be applied. More specifically, applying the positive address voltage V_{A} to an address electrode while applying a scan pulse of the ground voltage V_{G} to a Y electrode generates an address discharge, which forms wall charges at the selected discharge cell. More specifically, positive wall charges are accumulated on the Y electrode and negative wall charges are accumulated on the X electrode of the selected discharge cells. Wall charges are not generated at the non-selected discharge cells. In order to perform more accurate and effective address discharges, the X electrode may be biased at a sustain voltage Vₛ during the address period A.

A discharge gap between the X and Y electrodes may be narrowed to increase discharge efficiency. However, as the discharge gap narrows, the address discharge may be generated in both selected and non-selected discharge cells because of the voltage difference between the X and Y electrodes. Therefore, wall charges may accumulate on the X and Y electrodes of non-selected discharge cells, which may lead to an erroneous sustain discharge during the sustain period. Korean Laid-Open Patent Application No. 2002-0019342 discloses a technique for effectively performing an address discharge by lowering the scan voltage of the Y electrode. However, lowering the scan voltage of the Y electrode may increase the voltage difference between the X and Y electrodes, which may exacerbate the mis-discharge problem between the X and Y electrodes.

### SUMMARY OF THE INVENTION

The present invention provides a PDP having improved discharge stability.

Additional features of the invention will be set forth in the description which follows, and in part will be apparent from the description, or may be learned by practice of the invention.

The present invention discloses a PDP including a rear substrate, a front substrate disposed facing the rear substrate, partition walls disposed between the front substrate and the rear substrate to define discharge cells together with the front and rear substrates, sustain electrode pairs extending across the discharge cells and address electrodes extending in a direction substantially perpendicular to the sustain electrode pairs. A sustain electrode comprises a bus electrode and a transparent electrode, and the bus electrode extends across the discharge cells. The transparent electrode comprises a body portion disposed apart from the bus electrode in a direction toward a center of a discharge cell and a connection portion electrically connecting the body portion to the bus electrode. A ratio of a width of the body portion to a length of the connection portion is in a range of 1.2 to 2.2.

It is to be understood that both the foregoing general description and the is following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a waveform view showing signals that may be applied to electrodes in a conventional PDP.

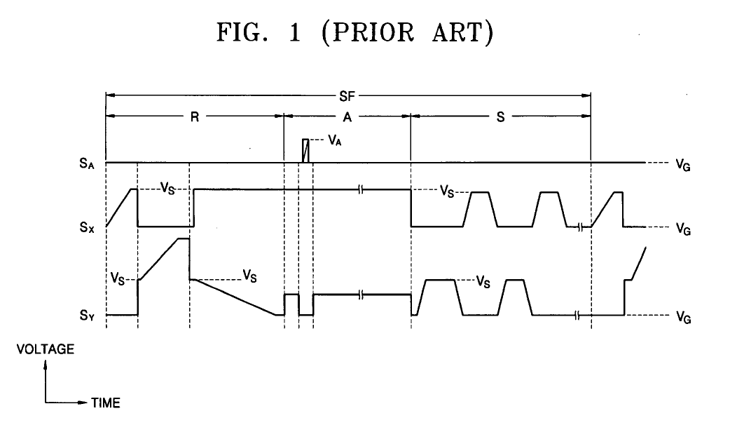

FIG. 2 is a partial cutaway perspective view showing a PDP according to an embodiment of the present invention.

FIG. 3 is a view showing discharge cells, partition walls, and sustain electrode pairs in the PDP of FIG. 2.

FIG. 4 is a waveform view showing signals that may be applied to electrodes in the PDP of FIG. 2.

### DETAILED DESCRIPTION OF THE ILLUSTRATED EMBODIMENTS

Hereinafter, exemplary embodiments of the present invention will be described in detail with reference to the attached drawings. Like reference numerals in the drawings denote like elements.

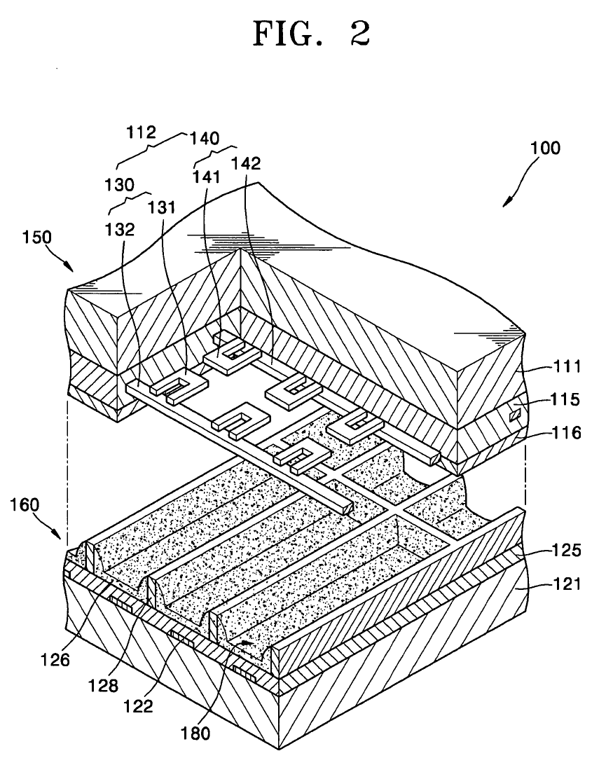

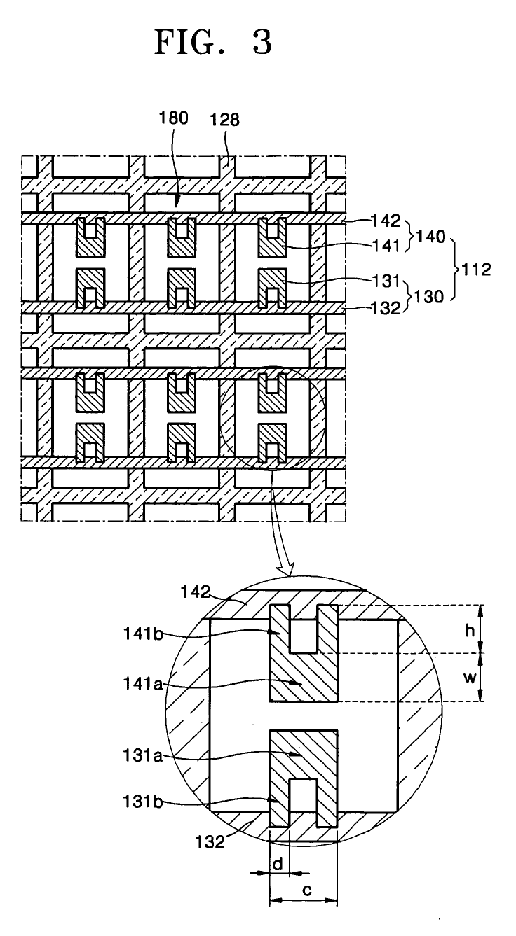

FIG. 2 and FIG. 3 show a PDP 100 according to an embodiment of the present invention.

The PDP 100 may include an upper plate 150 and a lower plate 160 coupled together. More specifically, the PDP 100 may include a rear substrate 121, a front substrate 111 facing the rear substrate 121, partition walls 128 disposed between the front and rear substrates 111 and 121 to define discharge cells 180 together with the front and rear substrates 111 and 121, sustain electrode pairs 112, address electrodes 122 extending in a direction to intersect the sustain electrode pairs 112, a first dielectric layer 125 covering the address electrodes 122, a second dielectric layer 115 covering the sustain electrode pairs 112, fluorescent layers 126 disposed in the discharge cells 180, and a discharge gas filled in the discharge cells 180.

The sustain electrode pairs 112 may be disposed on the front substrate 111 of the upper plate 150. Since visible light generated at the discharge cells 180 emits through the front substrate 111, the front substrate 111 is typically mainly made of a transparent material, such as, for example, glass.

The sustain electrode pairs 112 generate a sustain discharge. The sustain electrode pairs 112 may be arranged in parallel to each other at a predetermined interval on the front substrate 111. Each sustain electrode pair 112 includes an X electrode 130, serving as a common electrode, and a Y electrode 140, serving as a scan electrode.

Each X and Y electrode 130 and 140 may include a bus electrode 132, 142 extending across the discharge cells 180 and a plurality of transparent electrodes 131, 141, which are electrically connected to the bus electrode 132, 142. The transparent electrodes 131, 141 may be separately formed in a direction extending along the bus electrode 132, 142. Further, each transparent electrode 131, 141 may be disposed in a discharge cell 180.

The transparent electrodes 131, 141 may be made of a transparent conductive material for generating a discharge and transmitting light emitted from the fluorescent layers 126 to the front substrate 111. For example, the transparent conductive material may be indium tin oxide (ITO). However, since transparent conductive material typically has high resistance, a is discharge sustain electrode made of transparent material only may have a large voltage drop along its length, which increases power consumption and lowers a response rate. Accordingly, narrow, metallic bus electrodes 132, 142 may be disposed on the transparent electrodes 131, 141 to enhance the transparent electrodes' conductivity.

Referring to FIG. 3, the transparent electrodes 131, 141 may include a body portion 131a, 141a and connection portions 131b, 141b, which electrically connect the body portion 131a, 141a to the bus electrode 132, 142. The body portion 131a, 141a may be disposed apart from the bus electrode 132, 142 in a direction toward a center of the respective discharge cell 180. Further, the body portion 131a, 141a may be disposed substantially parallel to the bus electrode 132, 142, and the body portion 131a, 141a may be coupled to the bus electrode 132, 142 with two connection portions 131b, 141b. The connection portions 131b, 141b may be disposed substantially perpendicular to the bus electrode 132, 142. The connection portions 131b, 141b may be integrally formed together with the respective body portion 131a, 141a.

The address electrodes 122 may be disposed on the rear substrate 121 in a direction intersecting the X electrode 130 and the Y electrode 140.

The address electrodes 122 generate the address discharge to select discharge cells to be sustain discharged and to facilitate the sustain discharge between the X and Y electrodes 130 and 140. More specifically, the address electrodes 122 may lower a voltage required for generating the sustain discharge. The address discharge is generated between a Y electrode 140 and an address electrode 122. When the address discharge ends, positive ions and electrons are accumulated on the Y and X electrodes 140 and 130, respectively. Consequently, the sustain discharge between the X and Y electrodes 130 and 140 can be facilitated.

A pair of X and Y electrodes 130 and 140 and an address electrode 122 may intersect at a unit discharge cell 180.

The first dielectric layer 125 may be disposed on the rear substrate 121 to bury the address electrodes 122. The first dielectric layer 125 may be made of a dielectric material capable of inducing wall charges and preventing damage to the address electrodes 122 from collisions with positive ions and electrons during a discharge period. The dielectric material used for the first dielectric layer 125 may be, for example, PbO, B₂O₃, and SiO₂.

The second dielectric layer 115 may be disposed on the front substrate 111 to bury the sustain electrode pairs 112. The second dielectric layer 115 may be made of a dielectric material capable of inducing wall charges, preventing direct conduction between adjacent X and Y electrodes 130 and 140 during the sustain discharge, and preventing damage to the X and Y electrodes 130 and 140 due to collisions with the positive ions and electrons. The second dielectric layer 115 may also be made of, for example, PbO, B₂O₃, and SiO₂.

Additionally, a protective layer 116, which is typically made of magnesium oxide (MgO), may cover the second dielectric layer 115. The protective layer 116 prevents damage to the second dielectric layer 115 from collision with the positive ions and electrons. The protective layer 116 has a high transmittance, and it generates secondary electrons.

The partition walls 128 may be disposed between the first and second dielectric layers 125 and 115 to maintain a distance between the upper and lower plates 150, 160 and to prevent electrical and optical crosstalk between adjacent discharge cells 180.

Although FIG. 2 and FIG. 3 show the discharge cells 180 arranged in a matrix as defined by the partition walls 128, the partition walls 128 may have various patterns that define a plurality of discharge cells 180. For example, the partition walls 128 may have closed type patterns such as waffle, matrix, and delta patterns, as well as open type patterns such as a stripe pattern. Further, with the closed type patterns, the discharge cells 180 may have a cross section shaped like a rectangle (as in FIG. 2), triangle, pentagon, other polygons, circle, ellipse, or the like.

The red, green, and blue fluorescent layers 126 may be disposed on side surfaces of the partition walls 128 and on exposed portions of the first dielectric layer 125.

The fluorescent layers 126 contain a material (fluorescent material) that generates visible light after receiving ultraviolet rays. For example, the red fluorescent layers 126 may contain a fluorescent material such as Y(V,P)O₄:Eu, the green fluorescent layers 126 may contain a fluorescent material such as Zn₂SiO₄:Mn, and the blue fluorescent layers 126 may contain a fluorescent material such as BAM:Eu.

The discharge gas such as, for example, Ne, He, Xe, and a mixture thereof may be inserted and sealed in the discharge cells 180.

Now, operations of the PDP 100 will be described.

The PDP 100 may be driven in accordance with an ADS driving scheme where each image frame is divided into a plurality of subfields SF in order to implement time-division gray scale display. Each subfield SF may be divided into a reset period R, an address period A, and a sustain period S.

In the reset period R, discharge conditions of all discharge cells 180 are uniformly reset to be suitable for the following address period A.

In the address period A, display data signals are applied to the address electrodes 122 while simultaneously and sequentially applying scan pulses to the Y electrodes 140. Applying the positive address voltage VA to an address electrode while applying a scan pulse of the ground voltage VG to a Y electrode generates an address discharge, which forms wall charges at the selected discharge cell. Wall charges are not generated at non-selected discharge cells.

The PDP's brightness is proportional to the sustain-discharge time interval in the sustain period S. The sustain-discharge time interval in the unit frame may be 255T, where T is a unit time. Therefore, 256 gray scale levels, including the level of zero where an image is not displayed, may be displayed in the unit frame.

When the unit frame is divided into 8 subfields SF, the sustain-discharge time intervals of subfields SF1 through SF8 may be denoted as 1T, 2T, 4T, 8T, 16T, 32T, 64T, and 128T, which correspond to times 2⁰, 2¹, 2², 2³, 2⁴, 2⁵, 2⁶, and 2⁷, respectively.

The display is made by appropriately selecting a combination of the 8 subfields SF to display 256 gray scale levels including a non-display level (zero gray scale level).

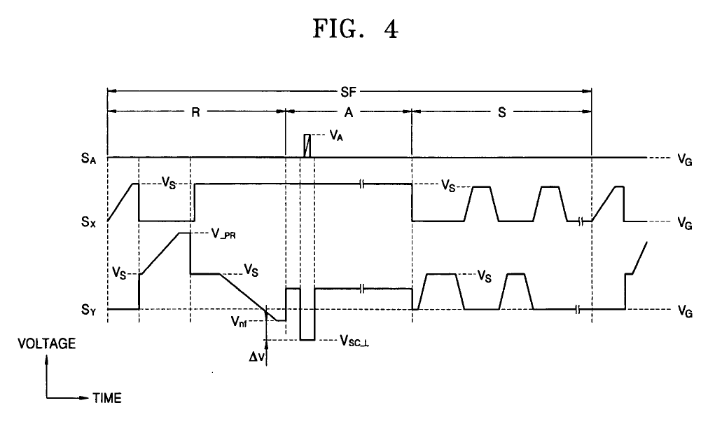

FIG. 4 is a waveform view showing driving signals Sₓ and S_{y}, which may be applied to X and Y electrodes 130 and 140, and a driving signal S_{A}, which may be applied to an address electrode 122, during a unit subfield SF according to an embodiment of the present invention.

As described above, a unit subfield SF may be divided into the reset period R, the address period A, and the sustain period S. During the address period A, a discharge cell 180 to be sustain discharged is selected. During the sustain period S, the sustain discharge is generated in the selected discharge cells.

Referring to FIG. 4, in the reset period R, the driving signal S_{Y} applied to the Y electrode 140 may increase to a first voltage V_{_{—}}_{PR} and then decrease to a second voltage V_{nf}, which is an ending voltage of the reset period R. Next, in the address period A, a scan pulse having a third voltage V_{SC}_{_{—}}_{L} (a scan voltage) may be applied to the Y electrode 140. Here, the second voltage V_{nf} may be higher than the third voltage V_{SC}_{_{—}}_{L} to stabilize the resetting of the sustain electrodes 131 and 132 and improve the address discharge characteristics.

As FIG. 3 shows, in the PDP 100 according to an embodiment of the present invention, the transparent electrodes 131 and 141 may be formed in a shape of ⊂, which includes the body portions 131a and 141a and the connection portions 131b and 141b. The body portions 131a and 141a spread the discharge to the surroundings when the discharge starts and also maintain the discharge. If widths w of the body portions 131a and 141a are much smaller than lengths h of the connection portions 131b and 141b, the discharge may not sufficiently spread and it may be generated only at the connection portions 131b and 141b. Therefore, the discharge is not effectively in the entire region of the discharge cell 180, so that a so-called low discharge may occur.

On the contrary, if the widths w of the body portions 131a and 141a are much larger than the lengths h of the connection portions 131b and 141b, the discharge area increases, and a mis-discharge may occur between the X and Y electrodes 130 and 140. Consequently, it can be understood that, with respect to various voltage differences (V_{nf}−V_{SC}_{_{—}}_{L}; hereinafter, denoted as ΔV) between the second and third voltages V_{nf} and V_{SC}_{_{—}}_{L}, there are ratios w/h of the widths w of the body portion to the lengths h of the connection portions that may improve discharge stability.

Table 1 shows discharge stability observed at 9 points when a window screen of a 6-inch test PDP increases by 1, 10, 20, 30, 40, 50, 60, 70, 80, 90, and 100%. The discharge stability can be quantitatively represented. For example, a value “0” represents a case where the low discharge and mis-discharge do not occur at any of the 9 points, and a value “9” represents a case where the low discharge and mis-discharge occur at all 9 points. As the test value of discharge stability approaches “0”, discharge stability increases. As the test value of discharge stability approaches “9”, discharge stability decreases.

TABLE 1
Test Value of Discharge Stability with
respect to Ratio w/h and Voltage Difference ΔV

| | | Voltage Difference (ΔV) | | | | | | | | | | |
|---|---|---|---|---|---|---|---|---|---|---|---|---|
| | | 0 | 1 | 2.5 | 5 | 10 | 12 | 20 | 25 | 30 | 35 | 40 |
| Ratio w/h | 0.8 | 3 | 2 | 3 | 4 | 4 | 5 | 7 | 8 | 9 | 9 | 9 |
| | 1.0 | 2 | 2 | 3 | 4 | 4 | 5 | 6 | 7 | 9 | 9 | 9 |
| | 1.2 | 1 | 0 | 0 | 0 | 0 | 0 | 0 | 0 | 0 | 0 | 7 |
| | 1.4 | 1 | 0 | 0 | 0 | 0 | 0 | 0 | 0 | 0 | 0 | 6 |
| | 1.6 | 2 | 0 | 0 | 0 | 0 | 0 | 0 | 0 | 0 | 0 | 5 |
| | 1.8 | 2 | 0 | 0 | 0 | 0 | 0 | 0 | 0 | 0 | 0 | 3 |
| | 2.0 | 1 | 0 | 0 | 0 | 0 | 0 | 0 | 0 | 0 | 0 | 3 |
| | 2.2 | 1 | 0 | 0 | 0 | 0 | 0 | 0 | 0 | 0 | 0 | 2 |
| | 2.4 | 6 | 7 | 4 | 4 | 4 | 4 | 3 | 2 | 2 | 2 | 2 |
| | 2.6 | 7 | 7 | 6 | 6 | 3 | 3 | 2 | 1 | 1 | 1 | 1 |

As Table 1 shows, the discharge stability is measured with respect to voltage differences ΔV of 0, 1, 2.5, 5, 10, 12, 20, 25, 30, 35, and 40V and ratios w/h of 0.8, 1.0, 1.2, 1.4, 1.6, 1.8, 2.0, 2.2, 2.4, and 2.6. Here, lengths c of the body portions and widths d of the connection portions are set to 216 μm and 56 μm, respectively. The sum (w+h) of the width w of the body portion and the length h of the connection portion is maintained at a constant value of 418 μm, while the ratio w/h changes.

As Table 1 shows, when the ratio w/h is in a range of 1.2 to 2.2, the discharge stability may be high. When the ratio w/h is less than 1.2, the low discharge may occur, so that discharge stability is low. When the ratio w/h is more than 2.2, the mis-discharge may occur, so that the discharge stability is also low. Therefore, in order to implement stable discharging for the PDP 100, the ratio w/h may be in a range of 1.2 to 2.2. In this case, the length h of the connection portion may be in a range of 120 to 200 μm, and the width w of the body portion may be in a range of 230 to 390 μm.

Additionally, when the voltage difference ΔV is in a range of 1 to 35 V, the low discharge and mis-discharge do not occur at any of the 9 points when the ratio w/h is in the range of 1.2 to 2.2. Therefore, the PDP 100 may be driven by setting the voltage difference ΔV in a range of 1 to 35V.

According to exemplary embodiments of the present invention, it is possible to implement a PDP having improved discharge stability.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A plasma display panel (PDP), comprising:
a rear substrate;
a front substrate disposed facing the rear substrate;
partition walls disposed between the front substrate and the rear substrate to define discharge cells together with the front substrate and the rear substrate;
sustain electrode pairs extending across the discharge cells; and
address electrodes extending to intersect the sustain electrode pairs,
wherein a sustain electrode comprises a bus electrode and a transparent electrode,
wherein the bus electrode extends across the discharge cells,
wherein the transparent electrode comprises a body portion disposed apart from the bus electrode in a direction towards a center of a discharge cell and a connection portion electrically connecting the body portion to the bus electrode, and
wherein a ratio of a width of the body portion to a length of the connection portion is in a range of 1.2 to 2.2.

2. The PDP of claim 1, wherein each sustain electrode of a sustain electrode pair comprises a plurality of transparent electrodes electrically connected to the bus electrode.

3. The PDP of claim 2, wherein the transparent electrodes are discontinuously disposed in a direction extending along the bus electrode.

4. The PDP of claim 3, wherein each transparent electrode is disposed corresponding to a discharge cell.

5. The PDP of claim 1, wherein the body portion is disposed corresponding to the discharge cell.

6. The PDP of claim 1, wherein the body portion is electrically connected to the bus electrode with two connection portions.

7. The PDP of claim 1, wherein the connection portion is substantially perpendicular to the bus electrode.

8. The PDP of claim 1, wherein the body portion is substantially parallel to the bus electrode.

9. The PDP of claim 1, wherein the connection portion is integrally formed together with the body portion.

10. The PDP of claim 1, wherein the length of the connection portion is in a range of 120 to 200 μm.

11. The PDP of claim 1, wherein the width of the body portion is in a range of 230 to 390 μm.

12. The PDP of claim 1, wherein a sustain electrode pair comprises a scan electrode and a common electrode.

13. The PDP of claim 12, wherein the PDP is driven in a reset period, an address period, and a sustain period, and
wherein an end voltage of the scan electrode in the reset period is higher than a scan voltage of the scan electrode in the address period.

14. The PDP of claim 13, wherein a difference between the end voltage of the scan electrode in the reset period and the scan voltage of the scan electrode in the address period is in a range of 1 to 35 V.
